(19) United States
(12) Patent Application Publication
(10) Pub. No.: US 2025/0292980 A1
(43) Pub. Date: Sep. 18, 2025

(54) MULTI-DIRECTIONAL INPUT APPARATUS

(71) Applicant: SHENZHEN ZESUM TECHNOLOGY CO., LTD., Shenzhen (CN)

(72) Inventors: Yusho NAKASE, Shenzhen (CN); Sen YANG, Shenzhen (CN); Chaoxian CHEN, Shenzhen (CN)

(73) Assignee: SHENZHEN ZESUM TECHNOLOGY CO., LTD., Shenzhen (CN)

(21) Appl. No.: 18/665,935

(22) Filed: May 16, 2024

(30) Foreign Application Priority Data
Mar. 18, 2024 (CN) 202420525828.8

(51) Int. Cl. H01H 36/00; H01H 25/00

(52) U.S. Cl. CPC H01H 36/0013; H01H 25/008; H01H 36/0033; H01H 2231/008

(57) ABSTRACT

Disclosed is a multi-directional input apparatus, including: a casing formed with a space, an operating body, a pressing plate, a supporting seat, a spiral spring, a connecting seat, a connecting seat, a connecting seat, a circuit board, an elastic sheet, and a magnetic sensing component. An opening portion is provided at an upper part of the space; the operating body is provided with an operating portion protruding upward from the opening portion and a shaking portion provided inside the space, and the shaking portion is provided with a fixed port; the circuit board is provided in the space; the magnetic sensing component includes a magnet provided in the fixed port and a magnetic sensor electrically connected to the circuit board; and the operating body, the magnet and a sensing portion of the magnetic sensor are coaxially provided.

### CROSS-REFERENCE TO RELATED APPLICATIONS

The present application claims priority to Chinese Patent Application No. 202420525828.8, filed on Mar. 18, 2024, the entire contents of which are incorporated herein by reference.

### TECHNICAL FIELD

The present application relates to the technical field of controller, and in particular to a multi-directional input apparatus.

### BACKGROUND

The multi-directional input apparatus of the rocker generally includes a casing, an operating member that can be tilted on the casing, two rocker arms that rotate according to the tilting action of the operating member, two sliding terminals that are respectively connected to the two rocker arms, and a circuit board that detects the sliding amount of the two sliding terminals and outputs corresponding signals. The multi-directional input apparatus of the rocker can be used for game control to implement game control platforms such as game controllers and arcade machines, and can trigger control instructions through the rocker.

In the existing multi-directional input apparatus of the rocker, when the rocker swings or tilts to trigger the magnetic signal, the magnet is combined with the shaking portion of the rocker through the sliding sleeve and connected to the outer surface of the shaking portion. In this way, there is a certain distance from the magnet to the rotation center of the rocker, thus the accuracy of detecting the shaking amount cannot be guaranteed, and additional components need to be installed, which will increase the detection error.

### SUMMARY

The main purpose of the present application is to provide a multi-directional input apparatus, aiming to improve the detection accuracy of the magnetic momentum of the rocker, improve the assembly accuracy without the need for additional connecting parts, and reduce the detection error when the rocker swings or tilts to trigger the magnetic signal.

In order to achieve the above purpose, the multi-directional input apparatus provided in the present application includes: a casing formed with a space, an operating body, a pressing plate, a supporting seat, a spiral spring, a connecting seat, a connecting seat, a connecting seat, a circuit board, an elastic sheet, and a magnetic sensing component;
an opening portion is provided at an upper part of the space;
a shape of the operating body is cylindrical; the operating body is provided with an operating portion protruding upward from the opening portion and a shaking portion provided inside the space, and the shaking portion is provided with a fixed port;
a pressing plate provided in the space and below the shaking portion, wherein the pressing plate is disk-shaped, and a hole is provided at a center of the pressing plate;
the supporting seat is cylindrical;
one end of the spiral spring is configured to squeeze an upper surface of the pressing plate against a bottom of the shaking portion, and the other end of the spiral spring is configured to squeeze the supporting seat so that the operating body is reset to a neutral position;
the connecting seat is provided below the casing;
the circuit board is provided in the space;
the elastic sheet is provided on the circuit board;
the pressing member is provided above the connecting seat and the elastic sheet, in response to that the operating body is pressed, one end of the pressing member is abutted against a bottom of the operating body, and the other end of the pressing member is abutted against the elastic sheet; and
the magnetic sensing component includes a magnet provided in the fixed port and a magnetic sensor electrically connected to the circuit board, the operating body, the magnet and a sensing portion of the magnetic sensor are coaxially provided, and the operating body is shaken or vertically pressed and the magnet is driven to move in any direction of X, Y, Z relative to the magnetic sensor, so that a magnetic force change of the magnet is sensed by the magnetic sensor to obtain a shaking direction and a shaking amount of the operating body.

In an embodiment, the circuit board is a printed circuit board (PCB).

In an embodiment, a center point of the magnet and a rotation center of the operating body are provided on a same horizontal plane.

In the present application, the multi-directional input apparatus includes the casing, the operating body, the pressing plate, the supporting seat, the spiral spring, the connecting seat, the circuit board, the elastic sheet, the pressing member and the magnetic sensing component. The casing is provided above the connecting seat, the casing is formed with a space, and an opening portion is provided at an upper part of the space. The shape of the operating body is slightly cylindrical, and the operating body is provided with an operating portion protruding upward from the opening portion and a shaking portion provided inside the space. The shaking portion is provided with a fixed port. The circuit board is provided in the space. The magnetic sensing component includes a magnet and a magnetic sensor. The magnet is in the fixed port of the shaking portion, and the operating body, the magnet and the sensing portion of the magnetic sensor are coaxially provided, which can reduce the connection of additional fixed devices and the magnet and the operating body, and can realize the induction between the magnet and the magnetic sensor. When the user's hand shakes or presses the operating body, the operating body swings or moves downward, and the position of the magnet changes correspondingly, which triggers the magnetic sensor. The multi-directional input apparatus receives information of the user's hand swinging or pressing the operating body, which can realize display or interactive functions. In the present application, the magnet is provided in the shaking portion of the operating body, which reduces the number of elements and the distance between the magnet and the shaking portion, improves the detection accuracy of the magnetic momentum of the rocker, improves assembly accuracy, eliminates the need for additional connecting parts, and reduces the detection error when the magnetic signal is triggered by the swing or tilt of the rocker.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a multi-directional input apparatus according to an embodiment of the present application.

FIG. 2 is a schematic cross-sectional structural view of the multi-directional input apparatus shown in FIG. 1.

FIG. 3 is a schematic exploded structural view of the multi-directional input apparatus shown in FIG. 1.

FIG. 4 is a schematic structural view of a multi-directional input apparatus according to an embodiment of the present application.

FIG. 5 is a schematic cross-sectional structural view of the multi-directional input apparatus shown in FIG. 4.

FIG. 6 is a schematic exploded structural view of the multi-directional input apparatus according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

The present application provides a multi-directional input apparatus 1.

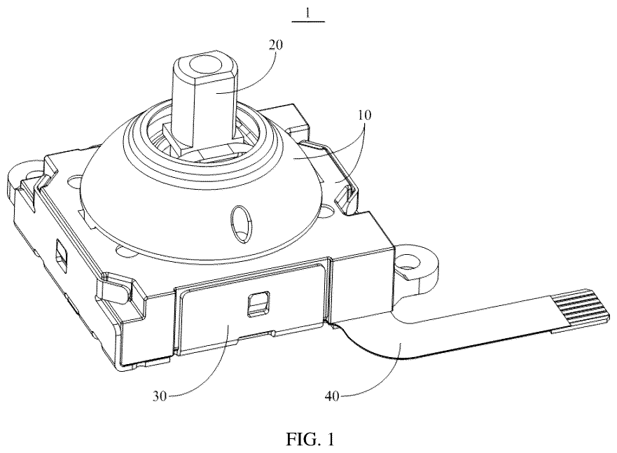

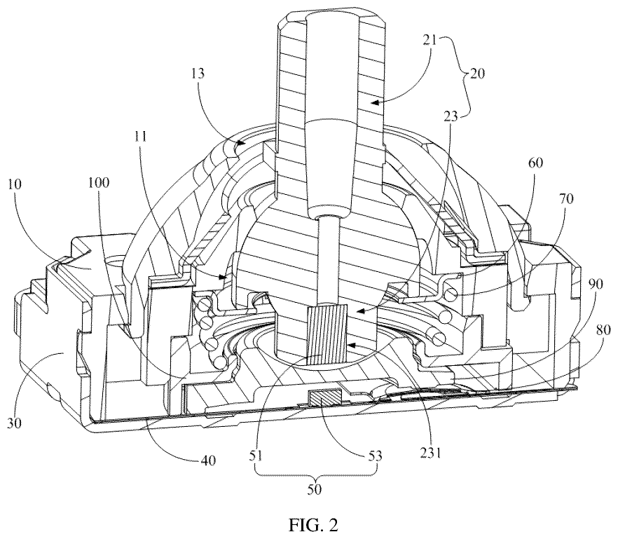

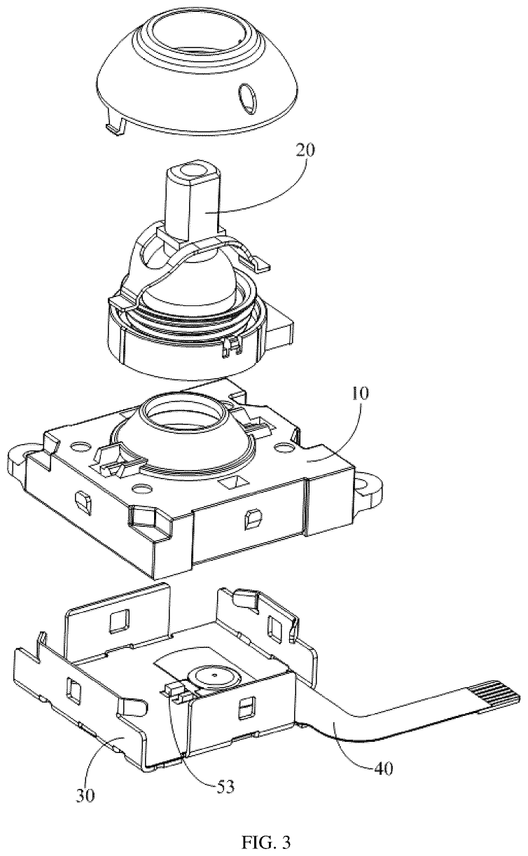

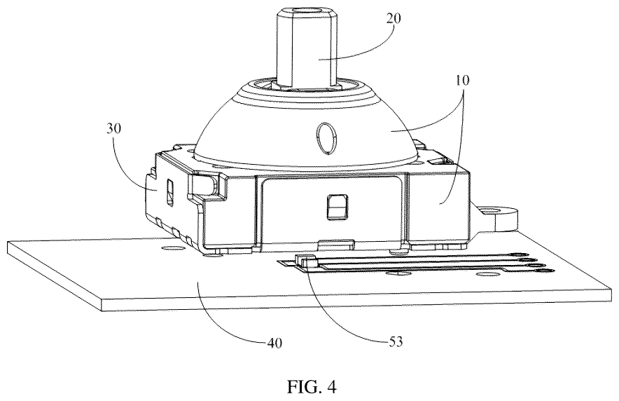

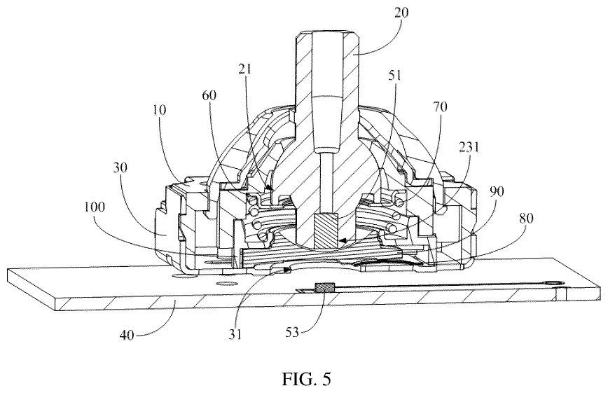

In an embodiment of the present application, as shown in FIG. 1 to FIG. 5, the multi-directional input apparatus 1 includes: a casing 10, an operating body 20, a pressing plate 60, a supporting seat 100, a spiral spring 70, a connecting seat 30, a circuit board 40, an elastic sheet 80, a pressing member 90, and a magnetic sensing component 50.

The casing 10 is formed with a space 11, and an opening portion 13 is provided at an upper part of the space 11.

The shape of the operating body 20 is slightly cylindrical, and the operating body 20 is provided with an operating portion 21 protruding upward from the opening portion 13 and a shaking portion 23 provided inside the space 11, and the shaking portion 23 is provided with a fixed port 231.

The pressing plate 60 is provided in the space 11 and is provided below the shaking portion 23. The pressing plate 60 is in the shape of a disk, and a hole is provided in a center of the pressing plate 60.

The supporting seat 100 is cylindrical.

One end of the spiral spring 70 squeezes an upper surface of the pressing plate against a bottom of the shaking portion 23, and the other end of the spiral spring 70 squeezes the supporting seat 100 to reset the operating body 20 to the neutral position.

The connecting seat 30 is provided below the casing 10.

The circuit board 40 is provided in the space 11.

The elastic sheet 80 is provided on the circuit board 40.

The pressing member 90 is provided above the connecting seat 30 and the elastic sheet 80. When the operating body 20 is pressed, one end of the pressing member 90 is abutted against the bottom of the operating body and the other end is abutted against the elastic sheet 80.

The magnetic sensing component 50 includes a magnet 51 provided in the fixed port 231 and a magnetic sensor 53 electrically connected to the circuit board 40. The operating body 20, the magnet 51 and the sensing portion of the magnetic sensor 53 are coaxially provided. The operating body 20 is shaken or vertically pressed and the magnet 51 is driven to move in any direction of X, Y, Z relative to the magnetic sensor 53, so that the magnetic sensor 53 senses the magnetic change of the magnet 51 to obtain the shaking direction and the shaking amount of the operating body 20.

The multi-directional input apparatus 1 includes a casing 10, an operating body 20, a pressing plate 60, a supporting seat 100, a spiral spring 70, a connecting seat 30, a circuit board 40, an elastic sheet 80, a pressing member 90 and a magnetic sensing component 50. The casing 10 is formed with a space 11, and an opening portion 13 is provided at an upper part of the space 11. The shape of the operating body 20 is slightly cylindrical and the operating body 20 is provided with an operating portion 21 protruding upward from the opening portion 13 and a shaking portion 23 provided inside the space 11. The circuit board is spaced apart from the shaking portion 23. The multi-directional input apparatus is also provided with a magnetic sensing component 50. The magnetic sensing component 50 includes a magnet 51 and a magnetic sensor 53. The shaking portion 23 is provided with a fixed port 231, the magnet 51 is provided in the fixed port 231, and the magnetic sensor 53 is electrically connected to the circuit board. The operating body 20 is shaken or vertically pressed and the magnet 51 is driven to move in any direction relative to the magnetic sensor 53, so that the magnetic sensor 53 senses the magnetic change of the magnet 51 to obtain the moving direction and moving amount of the operating body 20.

Further, the operating body 20, the magnet 51 and the magnetic sensor 53 are coaxially provided, which can ensure the synchronous displacement, the swing and the movement of the operating body 20 and the magnet 51, and increases the accuracy of the induction effect between the magnetic sensor 53 on the circuit board 40 and the magnet 51.

By shaking or vertically pressing the operating body 20, the magnetic sensor 53 can receive the signal change of the magnet 51, and the magnetic sensor 53 can transmit the signal change of the magnet 51 through the circuit board 40, which realizes the display and interaction of the signal after the operating body 20 moves. The magnet 51 can be a magnet, a charged object, etc. When the operating body 20 rotates or moves up and down, the distance or the angle between the magnet 51 and the magnetic sensor 53 changes, and the magnetic sensor 53 can determine the position change of the magnet 51 through the change of the direction of the magnetic field or the change of the magnitude of the current, thereby obtaining a transmission signal to realize the information transmission of the position change of the operating body 20. The shaking portion 23 is provided with a fixed port 231. The cross-sectional shape of the fixed port 231 is adapted to the cross-sectional shape of the magnet 51. When the magnet 51 is installed in the fixed port 231, the fixing and tightening of the fixed port 231 to the magnet 51 can be ensured, and the swing and pressing movements of the magnet 51 and the operating body 20 can be ensured to be synchronous. Furthermore, the depth of the fixed port 231 is adapted to the height of the magnet 51. When installed in the fixed port 231, the magnet 51 will not protrude from the opening of the fixed port 231, thereby avoiding the additional interference between the magnet 51 and the operating body 20 and the transmission parts inside the casing 10, and maintaining the smooth sliding and swinging of the operating body 20 inside the casing 10. The shaking portion 23 is provided with a fixed port 231, and the magnet 51 is provided in the fixed port 231, which ensures that the magnet 51 is provided inside the operating body 20, restricts the movement of the magnet 51 relative to the operating body 20, and ensures the moving synchronicity between the magnet 51 and the operating body 20. The magnet 51 is driven by the movement of the operating body 20 to synchronously and accurately trigger the magnetic sensor 53, and the magnetic sensor 53 can obtain the accurate and effective signal of the magnet 51.

Furthermore, the multi-directional input apparatus also includes an elastic sheet 80, and the elastic sheet 80 can be replaced by a disc spring, a spring, etc. The elastic sheet 80 is provided between the pressing member 90 and the circuit board 40 and is provided above the circuit board 40, and the pressing member 90 is abutted against the elastic sheet 80. The other end of the operating body 20 is slidably abutted against the other end of the pressing member 90, so that the operating body 20 can rotate relative to the pressing member 90 or push the pressing member to move. In this embodiment, the initial state of the elastic sheet 80 is a convex state. When the operating body 20 is pressed down, the operating body 20 presses in the direction of the pressing member 90 and the circuit board 40 so that one end of the pressing member 90 moves towards the direction of the circuit board 40 and presses against the elastic sheet 80. The elastic sheet 80 is compressed to have a reverse force on the operating body 20, and the user's hand touching the operating body 20 can receive the force and feel the feedback when pressing downward, so as to obtain the feedback signal of the operating body 20 pressed down.

Further, the multi-directional input apparatus also includes a pressing member 90 provided on the circuit board 40 and is spaced apart from the circuit board 40. The magnetic sensor 53 is provided between the pressing member 90 and the circuit board 40. One end of the pressing member 90 is rotatably connected to the operating body 20, and the other end of the pressing member 90 is abutted against the elastic sheet 80. The operating body 20 is pressed so that the pressing member 90 presses against the elastic sheet 80. In this embodiment, on the one hand, the pressing member 90 supports the operating body 20, so that the operating body 20 is spaced apart from the magnetic sensor 53 to maintain the position of the operating body 20 inside the space 11. On the other hand, the pressing member 90 can be used to transmit the downward pressure of the operating body 20, transmit the downward pressure of the operating body 20 to the elastic sheet 80, and conduct the feedback elastic force of the elastic sheet 80 to the operating body 20, thus realizing the connection between the operating body 20 and the circuit board 40 and the elastic sheet 80.

Further, the casing 10 is made of plastic material, and the connecting seat 30 is made of conductive material, such as stainless steel, iron, etc.

In the present application, the multi-directional input apparatus includes the casing 10, the operating body 20, the pressing plate 60, the supporting seat 100, the spiral spring 70, the connecting seat 30, the circuit board 40, the elastic sheet 80, the pressing member 90 and the magnetic sensing component 50. The casing 10 is formed with a space 11, and an opening portion 13 is provided at an upper part of the space 11. The shape of the operating body 20 is slightly cylindrical, and the operating body 20 is provided with an operating portion 21 protruding upward from the opening portion 13 and a shaking portion 23 provided inside the space 11. The shaking portion 23 is provided with a fixed port 231. The circuit board 40 is spaced apart from the shaking portion 23. The magnetic sensing component 50 includes a magnet 51 and a magnetic sensor 53. The magnet 51 is in the fixed port 231 of the shaking portion 23, and the operating body 20, the magnet 51 and the sensing portion of the magnetic sensor 53 are coaxially provided, which can reduce the connection of additional fixed devices and the magnet 51 and the operating body 20, and can realize the induction between the magnet 51 and the magnetic sensor 53. When the user's hand shakes or presses the operating body 20, the operating body 20 swings or moves downward, and the position of the magnet 51 changes correspondingly, which triggers the magnetic sensor 53. The multi-directional input apparatus receives information of the user's hand swinging or pressing the operating body 20, which can realize display or interactive functions. In the present application, the magnet 51 is provided in the shaking portion 23 of the operating body 20, which reduces the number of elements and the distance between the magnet 51 and the shaking portion 23, improves the detection accuracy of the magnetic momentum of the rocker, improves assembly accuracy, eliminates the need for additional connecting parts, and reduces the detection error when the magnetic signal is triggered by the swing or tilt of the rocker.

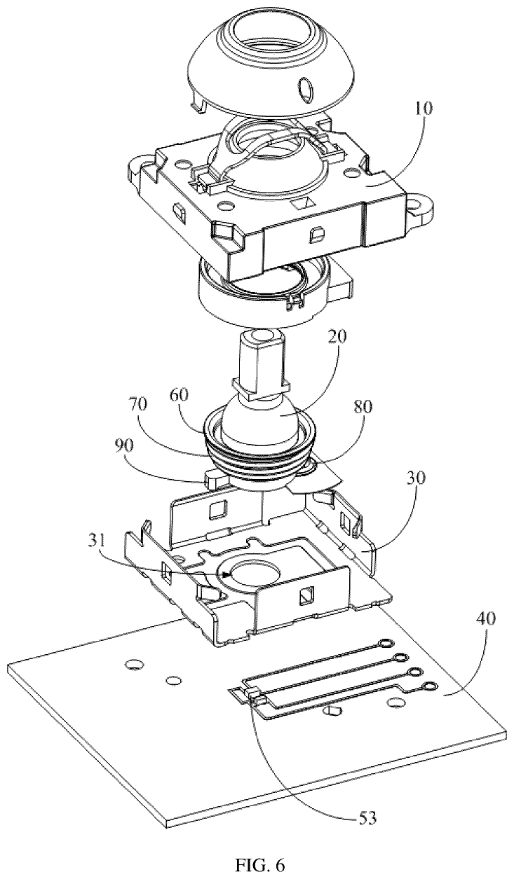

In an embodiment of the present application, as shown in FIG. 1 to FIG. 6, the circuit board 40 is a printed circuit board (PCB) board.

In an embodiment, the circuit board 40 is a flexible printed circuit (FPC) board connected to the connecting seat 30 and provided in the space 11. The multi-directional input apparatus can be controlled as a controller and collect and process the signals of the rocker through the FPC board.

In an embodiment, the circuit board 40 is a PCB board spaced on a side of the connecting seat 30 away from the casing 10. The multi-directional input apparatus can be connected to the PCB mainboard as an external controller, and output signals to the PCB mainboard through the rocker to control. Further, the connecting seat 30 is provided with a connecting notch 31, and the operating body 20 is electrically connected to the circuit board 40 through the connecting notch 31, so that the magnetic sensor 53 on the circuit board 40 can be magnetically induced by the magnet 51 through the connecting notch 31.

In an embodiment of the present application, a center point of the magnet 51 and a rotation center of the operating body 20 are on a same horizontal plane.

In this embodiment, the center point of the magnet 51 and the rotation center of the operating body 20 are on the same horizontal plane, which can ensure the consistence of the rotation angle of the magnet 51 and the rotation angle of the operating body 20, so that the true angle of the rocker can be more accurate through the feedback of the magnetic field calculation capability of the magnetic sensor 53. The magnet 51 is driven by the movement of the operating body 20 to synchronously and accurately trigger the magnetic sensor 53, and the magnetic sensor 53 can obtain the accurate and effective signal of the magnet 51.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A multi-directional input apparatus, comprising:
a casing formed with a space, wherein an opening portion is provided at an upper part of the space;
an operating body, wherein a shape of the operating body is cylindrical; the operating body is provided with an operating portion protruding upward from the opening portion and a shaking portion provided inside the space, and the shaking portion is provided with a fixed port;
a pressing plate provided in the space and below the shaking portion, wherein the pressing plate is disk-shaped, and a hole is provided at a center of the pressing plate;
a supporting seat, wherein the supporting seat is cylindrical;
a spiral spring, wherein one end of the spiral spring is configured to squeeze an upper surface of the pressing plate against a bottom of the shaking portion, and the other end of the spiral spring is configured to squeeze the supporting seat so that the operating body is reset to a neutral position;
a connecting seat provided below the casing;
a circuit board provided in the space;
an elastic sheet provided on the circuit board;
a pressing member provided above the connecting seat and the elastic sheet, wherein in response to that the operating body is pressed, one end of the pressing member is abutted against a bottom of the operating body, and the other end of the pressing member is abutted against the elastic sheet; and
a magnetic sensing component comprising a magnet provided in the fixed port and a magnetic sensor electrically connected to the circuit board, wherein the operating body, the magnet and a sensing portion of the magnetic sensor are coaxially provided, and the operating body is shaken or vertically pressed and the magnet is driven to move in any direction of X, Y, Z relative to the magnetic sensor, so that a magnetic force change of the magnet is sensed by the magnetic sensor to obtain a shaking direction and a shaking amount of the operating body.

2. The multi-directional input apparatus according to claim 1, wherein the circuit board is a printed circuit board (PCB).

3. The multi-directional input apparatus according to claim 1, wherein a center point of the magnet and a rotation center of the operating body are provided on a same horizontal plane.
